(19) United States
(12) Patent Application Publication
(10) Pub. No.: US 2005/0088435 A1
(43) Pub. Date: Apr. 28, 2005

(54) Novel 3D ear camera for making custom-fit hearing devices for hearing aids instruments and cell phones

(76) Inventor: Z. Jason Geng, Rockville, MD (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/973,119

(22) Filed: Oct. 25, 2004

Related U.S. Application Data
(60) Provisional application No. 60/514,155, filed on Oct. 23, 2003.

(51) Int. Cl. G06T 15/00

(52) U.S. Cl. 345/419

(57) ABSTRACT

An imaging device includes light source configured to project spatially varying light onto a surrounding scene, an image sensor; and imaging optics configured to direct the light from the surrounding scene onto the image sensor wherein a portion of the optics is configured to be placed within an inter ear canal.

### RELATED APPLICATIONS

The present application claims priority under 35 U.S.C. § 119(e) from the following previously-filed Provisional Patent Application, U.S. Application No. 60/514,155, filed Oct. 23, 2003 by Geng, entitled “Novel 3D Ear Camera for Making Custom-Fit Hearing Devices for Hearing Aids Instruments and Cell Phones” which is incorporated herein by reference in its entirety.

### BACKGROUND

More than 28 million Americans suffer from some type of hearing impairment, according to the statistics from National Institute on Deafness and Communication Disorders (NIDCD). It is estimated that over 260 million people are hearing impaired worldwide. Based upon the huge population involved, the hearing impairment is arguably the number one disability in today's world. Fortunately, many of these people can benefit from the use of a hearing aid. However, hearing aids cannot work for everyone. Those who can be helped need to be carefully fitted in order to gain the enhanced hearing functionality.

A hearing aid is an electronic device that picks up sound waves with a tiny microphone and amplifies and sends them to the ear through a tiny speaker. Hearing aids are frequently formed in an attempt to fit a given situation. Such examples may include tailoring the tuning the amplification characteristics of the electronics to correspond with an individual's hearing capability. In particular, hearing loss has a variety of patterns and degrees of severity and affects people in different ways, no single design fits everyone. Further, hearing aids are frequently custom made in an attempt to fit the geometric shape of ear pieces to individual ear anatomy.

Current manufacturing processes of custom-fit shells of hearing aids may be highly labor-intensive and manual process, and quality control of the fitting/performance of hearing aids may be difficult. A typical custom-fitting process starts with taking ear impression of a patient at the office of an audiologist or dispenser. The impression is then shipped to a manufacturer's laboratory. At the manufacturer's laboratory, each shell is frequently made by skilled technicians using manual operations. The quality and consistency of the fit of each shell vary significantly with the technician's skill level.

A typical process of producing a shell takes about 40 minutes from start to finish. Once the shell is finished, electronics will be installed, calibrated, and a quality check is performed. The hearing aid device will then be sent back to the audiology or dispenser who will try the device on the patient. If the hearing aid device does not fit well (only less than 75% fit well in the first installation), this lengthy, costly, and uncomfortable process will have to be repeated.

The process of taking physical ear impression may be uncomfortable to most patients. Further, the impression procedure exerts force to the ear structure directly that may cause deformation that affects the measurement accuracy, thus affecting the quality of fitting. In addition, it may be difficult for audiologists to obtain immediate feedback on the impression quality, until a subsequent appointment. Furthermore, an ear impression frequently record 3D ear shapes in a solid mold such that digital measurement cannot be directly obtained. This lack of 3D digital data make CAD-CAM processes less feasible.

### SUMMARY

An imaging device includes light source configured to project spatially varying light onto a surrounding scene, an image sensor; and imaging optics configured to direct the light from the surrounding scene onto the image sensor wherein a portion of the optics is configured to be placed within an inter ear canal.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic view of a manufacturing assembly according to one exemplary embodiment.

FIG. 1-1 illustrates a schematic view of a manufacturing process according to one exemplary embodiment

FIG. 2 illustrates a general schematic view of a three-dimensional imaging device according to one exemplary embodiment.

FIG. 3 illustrates a side view of a three-dimensional imaging device according to one exemplary embodiment.

FIG. 4 illustrates a schematic view of a light source according to one exemplary embodiment.

FIG. 4-1 illustrates a monochromatic filter according to one exemplary embodiment.

FIG. 5 illustrates a method of registering multiple three-dimensional images according to one exemplary embodiment.

FIG. 6 illustrates two images being registered into a single image according to one exemplary embodiment.

FIG. 7 illustrates a schematic view of registering two images according to one exemplary embodiment.

FIG. 8 illustrates an image processing technique according to one exemplary embodiment.

FIGS. 9-1 and 9-2 illustrate general schematic views of a dual-head three dimensional image device according to one exemplary embodiment.

FIG. 10 illustrates a schematic view of a dual-head three-dimensional imaging device according to one exemplary embodiment.

FIG. 11 illustrates a method of acquiring multiple three dimensional images according from a dual-head camera according to one exemplary embodiment.

Throughout the drawings, identical reference numbers designate similar, but not necessarily identical, elements.

### DETAILED DESCRIPTION

As previously discussed, a miniature 3D camera hardware design are provided for image acquisition, and software algorithms are provided to compute a digital model of the internal ear and ear canal that will enable standard CAD-CAM manufacturing of hearing aid shells. To the best of our knowledge, there is no other 3D imaging technology that is able to achieve the imaging quality and miniaturization level that our HW and SW can achieve, at any cost. The benefits of this invention include its potential to bring a radical change to the manufacturing process and techniques of hearing aids shells. The digital impressions enable the hearing aid manufacturers to take advantages of the latest breakthrough of CAD-CAM technologies and produce mass customization hearing aid device within one-day time frame. Even including the quality insurance, electronics calibration, and shipping back the hearing-aid device, the entire process of making custom-fit hearing aid devices would be shortened from weeks to few days. The digital impression technology may improve the fitting quality, thus facilitating a much smoother process of fitting a hearing aid and leading to more initial success in hearing aid users' acceptance and satisfaction.

This new method may also improve the actual acoustic properties of hearing aids by allowing new and heretofore unavailable accurate control over venting these devices often employed to precisely control amplification in various frequency ranges. The 3D digital ear model provides the ability to optimize the interior volume of the hearing aid to allow additional electronics to be added. All of these advantages lead to significant enhancement of the hearing functionality for impaired people.

Beyond the benefits to streamlining the manufacturing process of high quality low-cost custom-fit hearing aids for large population of hearing impaired individuals, the technology can also be applied to increasing number of personal listening devices (such as ear pieces for wearable computer and mobile phones) for virtually all normal hearing population. The commercial market of the envisioned 3D ear camera product is sizable and sales revenue could be quite significant.

The ultimate goal of this invention is to develop a viable commercial product that will provide reliable and low-cost 3D imaging capability to acquire accurate 3D digital ear impressions and produce high quality custom-fit hearing aids. Enormous commercial potential virtually guarantees the deployment of the handheld 3D ear camera as a widely acceptable tool for making custom-fit ear pieces.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

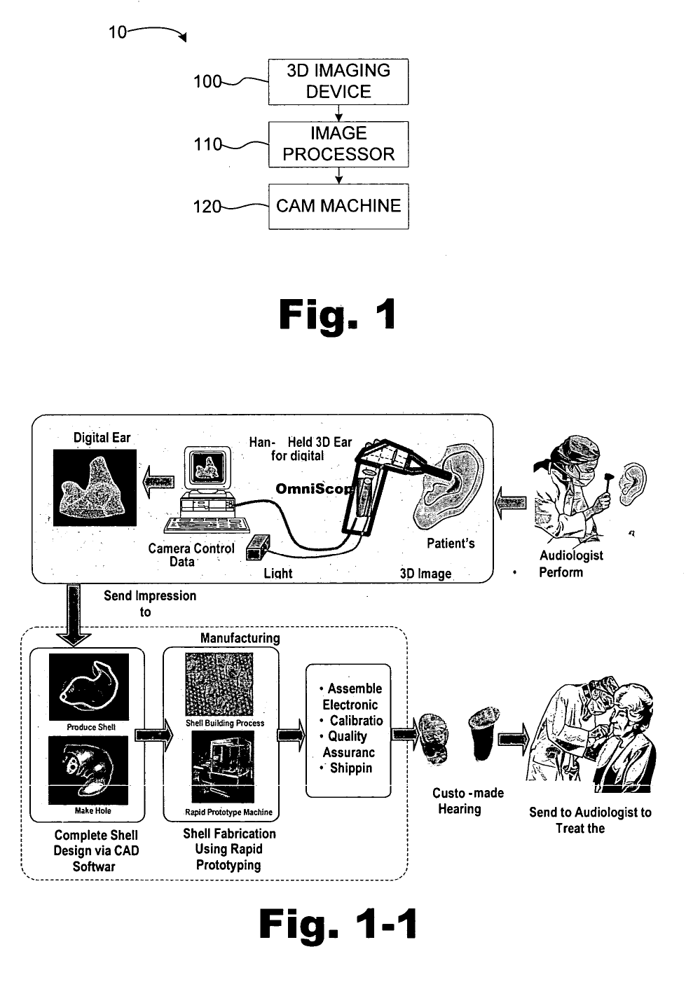

FIG. 1 illustrates a general schematic view of several components of an imaging and manufacturing system (10) used in the process of fabricating devices custom manufactured for location at least partially within an individual patient's ear. These components generally include a three dimensional (3D) imaging device (100), an image processor (110), and a CAM machine (120).

The 3D imaging device (100) is configured to rapidly obtain 3D imagines of portions of the patient's ear, including the inner ear canal. Several exemplary 3D imaging devices (100) will be discussed herein. The details of several exemplary devices, including the particular lens configurations, will be discussed in more detail below. Each of these devices directs light from a panoramic scene to a sensor. The sensor converts the light into digital signal or data corresponding to the panoramic scene. This data is then sent to the image processor (110).

The image processor (110) processes the data to form digital three dimensional images corresponding to a digital ear model. The 3D digital ear model serves as a “digital ear impression”. Once the digital ear impression has been formed, the digital ear impression data may then be sent directly to a manufacture's lab, such as by sending the digital ear impression electronically via the Internet or other suitable means.

The digital impressions may enable the hearing aid manufacturers to take advantages of the latest breakthrough of computer-aided-design (CAD), and computer aided manufacturing (CAM) technologies, to rapidly produce custom hearing aid devices within a compressed time frame. For example, a complete diagnostic, design and fabrication process, including the quality insurance, the electronics calibration, and the shipping of the hearing-aid device, the entire process making custom-fit hearing aid devices may be shortened from a period of weeks to a period of a few days.

Further, the digital impression systems and methods discussed herein may improve the quality of fit for each user, thus increasing the hearing functionality for impaired people. This new technology may also improve the actual acoustic properties of hearing aids by allowing new and heretofore unavailable accurate control over the venting of such devices often used to precisely control amplification in various frequency ranges. The accurate 3D geometry also provides the ability to optimize the interior volume of the hearing aid to allow additional electronics to be added.

Accordingly, the present system and method provides for a CAD (Computer-Aided-Design) shell design software for custom fit hearing aid devices, a handhold 3D Ear Camera that provides digital impression directly from patient's ear, and a CAM machine that configured to take the CAD file and fabricate the custom-designed shells directly while minimizing or eliminating the use of molding.

Exemplary Three-Dimensional Imaging Device

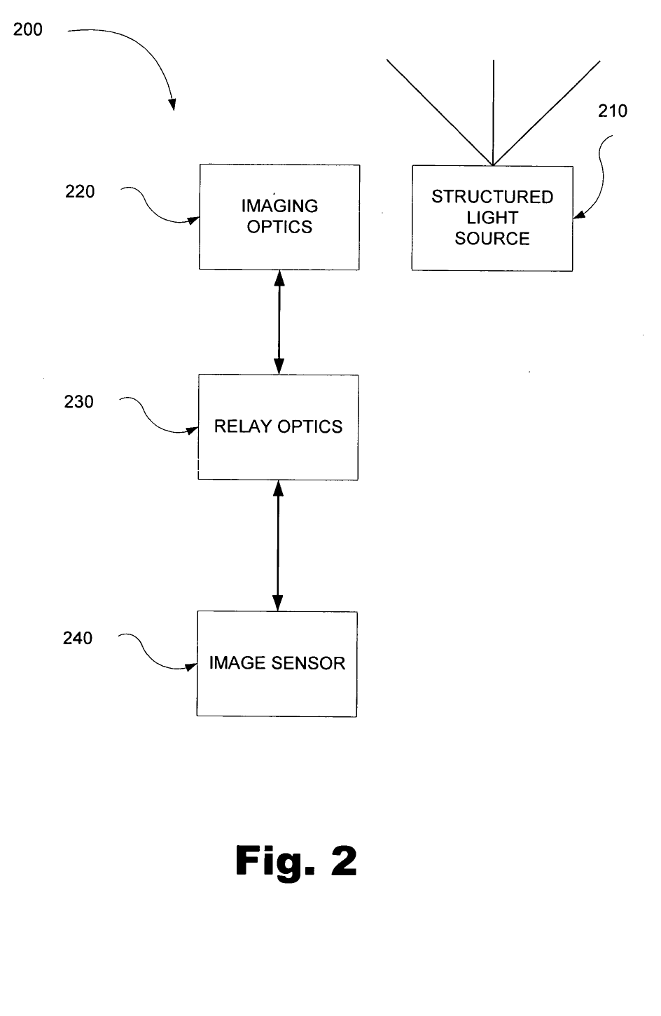

FIG. 2 illustrates a general schematic view of an exemplary three-dimensional (3D) imaging device (200) that captures images of surfaces within a three-dimensional field of view. The 3D imaging device (200) includes a structured light source (210), imaging optics (220), relay optics (230), and an image sensor (240). The specific details and characteristics of several exemplary imaging devices will be discussed below. The general characteristics of these devices will be discussed below.

The structured light source (210) directs structured light to illuminate a field of view. For example, the light source (210) maybe configured to project light patterns with a known spatially distributed wavelength using a linear variable wavelength filter (LVWF). An exemplary LVWF includes, without limitation, an optical glass plate coated with gradually varying wavelengths of colors. The wavelength of the coated color in a specific location on the LVWF is linearly proportional to the displacement of the location from LVWF's blue edge. This feature provides a simple and elegant way of generating structured light for an entire scene simultaneously while reducing or eliminating the use of moving parts.

In particular, the structured light source (210) generates a fan beam of light with broad spectrum (white light) which passes through a linear variable wavelength filter to illuminate 3D objects in the scene with a rainbow-like spectrum distribution. Due to the fixed geometric relationship among structured light source (210), the imaging optics (220), and the LVWF, there exists a one-to-one correspondence between the projection angle of the plane of light, and the wavelength of the light ray.

The reflected light from object surface is directed from the imaging optics (220) to the relay optics (220) and to the image sensor (240). This light is then detected by the image sensor (240). In a visible spectrum (400-700 nm), the color detected by the camera pixels is determined by the proportion of its primary color Red, Green, and Blue components (RGB). The color spectrum of each pixel has a one-to-one correspondence with the projection angle of the plane of light due to the fixed geometry of the imaging optics (220) and the characteristics of the LVWF characteristics. Accordingly, the detected color spectrum provides the projection angle.

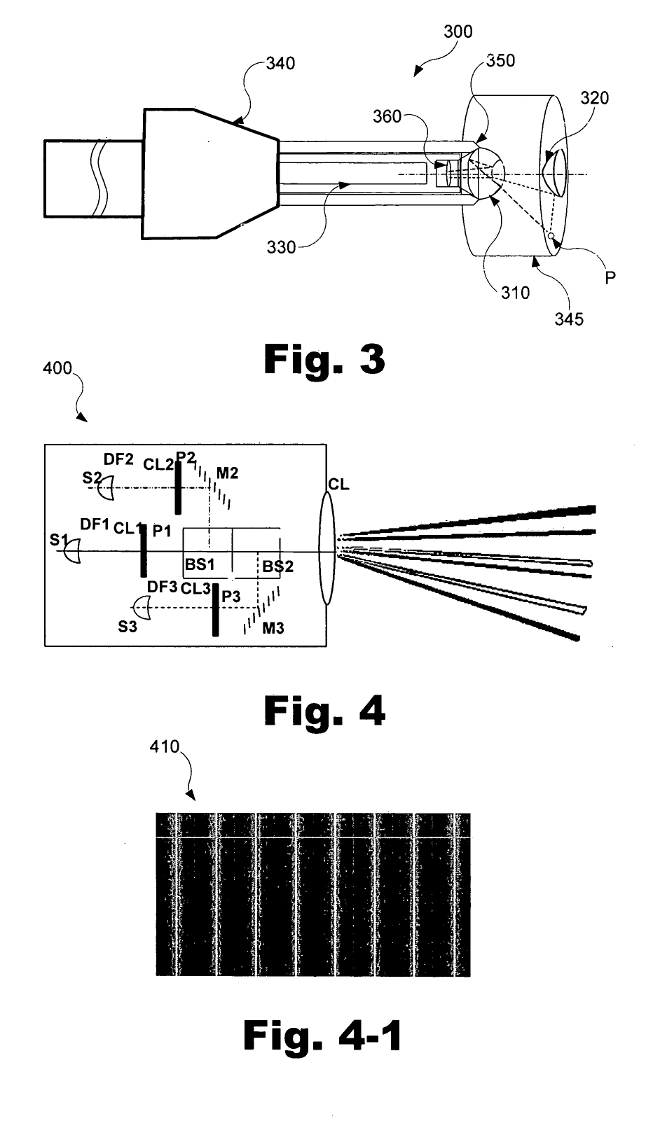

In particular, the angle is determined by the geometrical arrangement of the image sensor (240) and coordinates of each pixel on the image plane of the image sensor (240). The base line between focal point of the imaging optics and the center of the imaging optics (220 is fixed and known. The angle value, together with known baseline length and focal characteristics provide all necessary information to determine the full field of 3D range values (x,y,z) of any spot on the surface of objects seen by the imaging device (200). One exemplary imaging device will now be discussed in more detail with reference to FIG. 3.

Inner Canal Imaging Device

FIG. 3 illustrates an exemplary inner canal imaging device (300). The imaging optics (200; FIG. 2) described with reference to FIG. 2 includes forward looking optics (310), rearward looking optics (320), and a rod lens (330). The optical centers of the forward looking optics (310) and the rearward looking optics (320) and the optical axis of the rod lens (330) are collinear or are disposed along a single axis.

The rod lens (330) is used to relay the image acquired at the tip of the device back to an image sensor (340), such as a charge couple device (CCD) or CMOS. The image sensor (340) is divided into two areas—a forward looking sensor area and a rearward looking sensor area. At the tip of the rod lens (330), special optical lenses are mounted to shape the optical path. The central area of the sensor is associated with the field of view (FOV) (345) covered by the rearward looking optics (320), such as an Omni-Mirror.

The reflection from the rearward looking optics (320), passes through a transparent tube, which may enables the sensor to acquire panoramic images around the probe. The transparent tube also provides structural support to the omni-mirror. The forward looking optics (310) enables the collection of forward-looking images of the same FOV (345) covered by the rearward looking optics (320). Together with both the rearward-looking and forward-looking image sensor areas, the probe is able to produce 360-degree stereoscopic image pair of the same area.

The function of the iris and optical relay lens, such as the rod lens (330) is to collimate the optical path from the image sensor (340) to the forward looking optics (320) or omni-lens. The viewing ray from the image sensor (340) is thus converted into parallel beams entering into the optical interface of the omni-lens (320). The interface is designed as a substantially fiat surface to reduce or eliminate optical distortion. The parallel beam passing through the interface hits the first reflective surface on the top of the omni-lens (320). The optical geometry of the reflective surface may be hyperbolic surface in order to form a single viewpoint for the reflected rays. These rays will be bounced back to a second reflective surface, and further pass through a refractive surface to compensate certain non-linearity of the entire optical system. Both the optical lens and the omni-lens will be supported by a tube enclosure. The overall sensor configuration is thus very compact.

A light ring (350) surrounding the rod lens provides illumination for the probe. In particular, the light ring (340) directs structured or spatially varying wavelengths to illuminate the surrounding area or three-dimensional field of view (350). The structured light that illuminates the surrounding area then passes through either the forward looking optics (320) or the rearward looking optics (320). These optics direct the light to an iris lens (360). The iris lens (360) collimates the light and directs it to the rod lens (330), which in turn directs the light to an image sensor (340).

An object (P) with the FOV (350) is illuminated with structured light. A pair of 2D images of the same object is acquired from two different viewing angles. In particular, a stereoscopic algorithm may be used to find the corresponding points between two images. In addition to being coaxial, the virtual imaging centers of rearward and forward looking optics (320, 330) are separated by a known distance, which forms the baseline for the stereovision.

Once it is determined that the same point is being viewed, the viewing angles, from the virtual viewpoints can be determined. The projection angles are determined from the wavelength of the structured light detected, due to the one-to-one corresponding relationship between the wavelength and the projection angle. The distance between the optical center of the forward looking optics (320) and the object in the field of view (350) can be calculated using a straight forward triangulation principle:

$$R = \frac{sin ( {α}_{1} )}{sin ( {α}_{1} + {α}_{2} )} B ,$$

where R is the distance between the point and the optical center of the forward looking optics, and α₁ and α₂ are the angles between a line normal to both of the viewing centers and the angle of incidence of each of the light rays and B is the baseline distance between the optical centers of the forward and rearward looking optics (320, 330).

The optical path of a viewing ray, starting from the sensor chip, passes a set of optical lenses (such as the rod lens, etc) with desired parameters. The ray then enters into the forward looking optics (320) and travels rightward until it is reflected by a convex-shape internal reflective surface (the primary reflective surface). The internal reflective surface, shaped similar to that of the rearward looking optics (330), provides the omnidirectional 360° imaging capability. The reflected viewing ray then hits the secondary reflective surface (the secondary reflective surface) in the low-portion of the lens. The shape of the lens surface is designed such that it will refract the ray outward in 360° so that the image sensor will be able to see the omnidirectional scene.

The shape of refractive surface also compensates the certain type of non-linearity of the Omni-Mirror geometry. The forward looking optics (320) may include several features. For example design may be compact such that the components of the device may be integrated within a single piece that includes reflective mirrors and one curved refractive surface. Further, these optics may be well protected. In particular, the close configuration may provide environmental protection to handle the clinical abuse conditions.

Additionally, the design may be robust in that the need for subsequent alignment is minimized or elimination. For example, the optics may be integrated within the device in a fixed relationship. In addition, the refractive surface can be designed to compensate for certain non-linearities of the rearward looking optics or omni-mirror (330), thereby allowing more pixels to cover peripheral viewing areas therefore effectively increasing the resolution of the panoramic image used by the device in generating 3D images.

At the proximal end, an optical coupler is used to connect a high-resolution video camera to the device (300). A host computer with frame grabber may be used to acquire and store video images and perform image-processing functions, as will be discussed in more detail below.

Accordingly, the inner canal imaging device may provide simultaneous omni-directional imaging capabilities, detection of stereoscopic image pairs based on which 3D shape of the ear canal can be calculated; minimal use of moving parts, a combination of the forward looking and peripheral panoramic imaging capability, and structural and optical designs which are relatively simple thereby possibly allowing for a reliable and low-cost instrument. The device described with reference to FIG. 3 was described as an inner canal imaging device. As will be discussed in more detail below, the inner canal imaging device may be combined with an outer ear imaging device.

By way of reference, the light source (330) provides light of spatially varying wavelengths to the surrounding scene. In particular, a multiple rainbow projection (MRP) light source may be used to project several patterns onto the surrounding scene. In such a case, for a given wavelength, there may be multiple possible projection angles. There may no longer be a one-to-one corresponding relationship in the MRP. Although color-angle lookup table has the one-to-many mapping property in MRP, the search space can be confined to a single cycle of rainbow variation to achieve a one-to-one correspondence. Within one cycle of the rainbow projection, the solution to color match becomes unique.

For example, an adaptive control scheme may be used to determine the initial search point. In particular, when using a local search method in a one-to-many MRP, the outcome of the search may be at least partially dependent upon the initial condition. If a search starts within a neighborhood of the solution, it can achieve a correct result. The initial point of a search is determined by a previously obtained correct match point adjacent to it. The underlying assumption here is that a large portion of surface of a physical object is continuous, thus the projected color is similar, and projection angle should be very similar.

Exemplary Light Source

FIG. 4 illustrates a schematic view of a light source (400) configured to generate multi-rainbow projection illumination using multiple monochromic pattern filters (P1, P2, P3) with prism beamsplitters (BS1, BS2). Each of the monochromic pattern filters (P1, P2, P3) have linear variation with multiple periods of cycles. There is a 120 degree phase shift between three filters. The light from the light sources (S1, S2, S3) pass of different colors through corresponding light collection optics or diffusers (DF1, DF2, DF3) and intermediate optics (CL1, CL2, CL3) and the pattern filters (P1, P2, P3). An exemplary pattern (410) is shown in FIG. 4-1.

The pattern filters (P1, P2, P3) may be saw-tooth patterns that have linear variation in the entire period except for the two peaks. The uncertainty at the peaks of one pattern can be compensated by other two patterns on the other pattern filters. Light passes from the sources through the pattern filters.

Thereafter, in the schematic shown, the light is directed to the beamsplitters (BS1, BS2), either directly or by way of reflective mirrors (M2, M3). Accordingly, the light from the light sources (S1, S2, S3) is thus combined and passed through an objective lens (CL) to produce multiple cycle rainbow-like patterns. The light sources (S1, S2, S3) may be miniature light sources (such as LEDs), which provide illumination energy. The prism beamsplitters (BS1, BS2) with 45-degree beam-splitters are used to combine the light in different colors and phases.

After the individual beams have been combined, the projection optics is able to generate the multi-rainbow projection onto the surface of the object. Some materials used in producing suitable LEDs include, without limitation AlGaAs (red), InGaAlP (yellow-green through red) and InGaN (blue, green, and white). Package types can be leaded as well as surface-mounted. Off-the-shelf, high brightness LED components are readily available in the commercial market. The use of LEDs may provide for high lighting efficiency, by drawing low current draws (˜1 A max). Further, LEDs may provide light within a relatively narrow spectrum band, such as ˜30 nanometer bandwidth vs. traditional wideband white light projection. Additionally, LEDs may provide for fast response times. The LED package may have relatively high narrow band illumination per watt. For example, a green LED at 519 nm could reach 170 lumen flux output with efficiency of 36 lumens/watt.

Further, LEDs may provide nanosecond response times vs. seconds for halogen lamps. When synchronized with CCD/CMOS sensor acquisition timing, such fast response projection devices can achieve very strong projections while making them virtually undetectable due to the slow response time of human eyes. Furthermore, LED lamps may have long life, such as 100,000 hours vs. typical 1000 hours for halogen lamps all in a compact size. For example, some LEDs may provide footprints of approximately 6 mm in diameter and very high power (1 watt) LEDs that are ideal choice for our handheld camera applications.

The light source (400) thus discussed may be configured for use in an inner canal imaging device (300) such as that shown in FIG. 3. In particular, light that exits the objective lens (CL) may then be directed to the light ring (350). For example, the light may be directed to fiber optics, that convey the light around the outer perimeter of the rod lens (330). The light ring (350) then directs the light to the surrounding scene. Any suitable method may be used to direct the light from the light source (400) to the light ring (350).

Exemplary Image Sensor

Any suitable image sensor may be used. Suitable image sensors have acceptable acquisition speed to minimize the impact of hand motion and patient movements. Standard NTSC video cameras acquire 30 frames per second (fps) of 640×480 images. Image analysis was performed to assess the quality of the image in two major aspects related to motion: (1) Blurs of features in single image caused by the hand motion; (2) Feature point shift between image frames. Holding a video camera on hand without touching any part of body or supporting structure (i.e., free hand style), the shift of features in video image between two consecutive frames are 0.3428 pixels for a 30 fps camera, and 0.1686 pixels for a 60 fps camera. The use of a holding style wherein the operator uses her small finger to touch the boney structure on patient's face to obtain support of his hand may improve the stability of video image acquisition. Exemplary tests showed that the feature shift between two consecutive frames may be reduced to 0.1123 pixels for 30 fps camera and 0.0872 pixels.

Based on the hand motion testing results, and other considerations such as the signal to noise ratio, small size and lightweight for handheld unit, spectral response, and cost, we selected the SONY™ industry CCD sensor due to its resolution, sensitivity, S/N ratio, and reliability. The optical probe that is designed to measure the shape of ear canals should have small diameter (<2 mm), with focal length <2 mm, wide field of view (˜120-degree FOV), and a resolution of about 50 microns. We performed an integrated design of packaging both the MRP channel and the CCD image acquisition channel into a thin probe (a few mm in diameter).

We selected image sensor for the NFOV imaging channel. Dual to its compact size, we may choose ¼″ CCD chip to collect video image. There are image sensor IC Chips commercially available to perform integrated image acquisition, processing and interface with CCD (such as OV7620 from OmniVision Tech and ICX038DNA/ICX058CK from SONY). Also, there are high-resolution and low-cost CMOS chips available on the market.

The image devices described herein are configured to acquire full field dynamic 3D images of objects with complex surface geometry at high speed. “Full Field 3D image” shall be broadly understood to mean the value of each pixel (i.e., picture element) in an acquired digital image represents the accurate distance from the camera's focal point(s) to the corresponding point on the object's surface. The (x,y,z) coordinates for all visible points on the object surface can be provided by single 3D image. Operating principle of a rainbow 3D camera is based on triangulation principles.

A triangle is uniquely defined by angles theta (θ), alpha (α), and the length of the baseline (B) between the image sensor and the light projector. With known values of θ, α, and B, the distance (i.e., the range R) between the image sensor and any point Q on object's surface can be easily calculated. Since B is pre-determined by system configuration, and the value of θ can be calculated from the device's geometry, the key in the Triangulation method is to determine the projection angle, α, from an image captured by the image sensor.

The novel Rainbow 3D Camera makes use of projected light patterns with a known spatially distributed wavelength using a linear variable wavelength filter (LVWF). A LVWF is an optical glass plate coated with gradually varying wavelengths of colors. The wavelength of the coated color in a specific location on the LVWF is linearly proportional to the displacement of the location from LVWF's blue edge. This feature provides a simple and elegant way of generating structured light for an entire scene simultaneously while reducing or eliminating the use of moving parts.

The LVWF generates a fan beam of light with broad spectrum (white light) which passes through a linear variable wavelength filter to illuminate 3D objects in the scene with a rainbow-like spectrum distribution. Due to the fixed geometric relationship among light source, lens, and the LVWF, there exists a one-to-one correspondence between the projection angle (θ) of the plane of light, and the wavelength (λ) of the light ray.

The reflected light from object surface is detected by an image sensor, such as a color video camera. In a visible spectrum (400-700 nm), the color detected by the camera pixels is determined by the proportion of its primary color Red, Green, and Blue components (RGB). The color spectrum of each pixel has a one-to-one correspondence with the projection angle (θ) of the plane of light due to the fixed geometry of the lens and the LVWF characteristics; therefore the detected color spectrum provides the projection angle θ. Angle α is determined by the geometrical arrangement of the image sensor and coordinates of each pixel on camera's image plane. The base line between camera focal point and the center of the cylindrical lens may be fixed and known. The angle value α and θ, together with known baseline length B provide all necessary information to determine the full field of 3D range values (x,y,z) of any spot on the surface of objects seen by the camera.

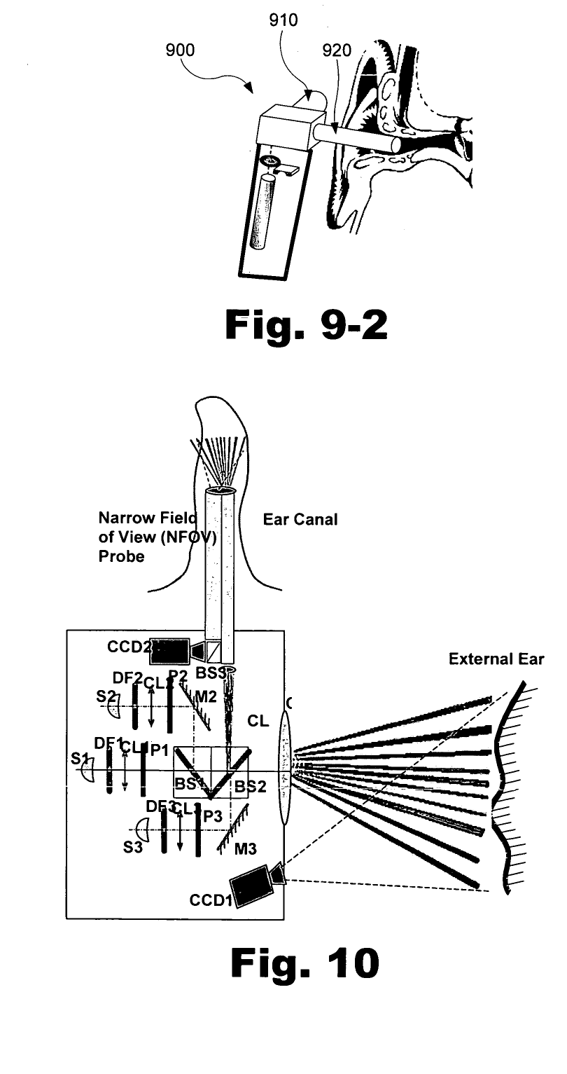

We performed rigorous theoretical analysis on the error sensitivity (detailed analysis is provided in our recent US patent applications entitled “Improvement on the Three Dimensional Imaging Methods and Apparatus”) and found that the accuracy of color match operation used in our Rainbow 3D camera scheme has a major effect on the accuracy of 3D images. The accuracy of color match, in turn, is significantly determined by the color variation rate of the projected light pattern. This analysis leads to the “Multi-Rainbow Projection (MRP)” concept, as shown in FIG. 9. Instead of changing the wavelength in single cycle, we can design a projection pattern that varies the wavelength several times crossing the entire field of view. The MRP pattern may illuminate the scene with greater wavelength variation rate thus is expected to achieve higher sensitivity in color matching. The accuracy of 3D measurement can then be improved.

Design of the Miniature 3D Ear Camera

Previous sections discussed our investigations on various key components of the 3D ear camera. This section describes our system design. We have performed detailed optical/structural design using computer-aided design (CAD) software. The optical system design was carried out using ZEMAX. In our system, the baseline separation may be approximately 25 mm, while standoff distance is selected as 115 mm. This leads to a converging angle of about 12-degree. The field of view (FOV) of the prototype was chosen as 32 mm×24 mm, and the depth of field (DOF) is 12 mm. These design parameters may allow the prototype for acquiring acceptable images with measurement accuracy of about 100 microns.

Geometric Calibration

In order to improve the geometric accuracy, we have developed a calibration procedure that provides both the extrinsic (relative pose) and intrinsic (focal length, lens distortion, aspect ratio) parameters of an image sensor, such as a CCD camera. The calibration software may include up to six order of radial distortion (K₁, K₂, and K₃ terms) as well as two terms of de-centering distortion (P₁ and P₂):
x′=x+x*(K₁*r²+K₂*r⁴+K₃*r⁶)+P₁*(r²+2*x²)+2*P₂*x*y
y′=y+y*(K₁*r²+K₂*r⁴+K₃*r⁶)+P₂*(r²⁺2 *y²)+2*P₁*x*y
   3D Image Processing Algorithms for Registering Multiple Un-Calibrated 3D Ear Images

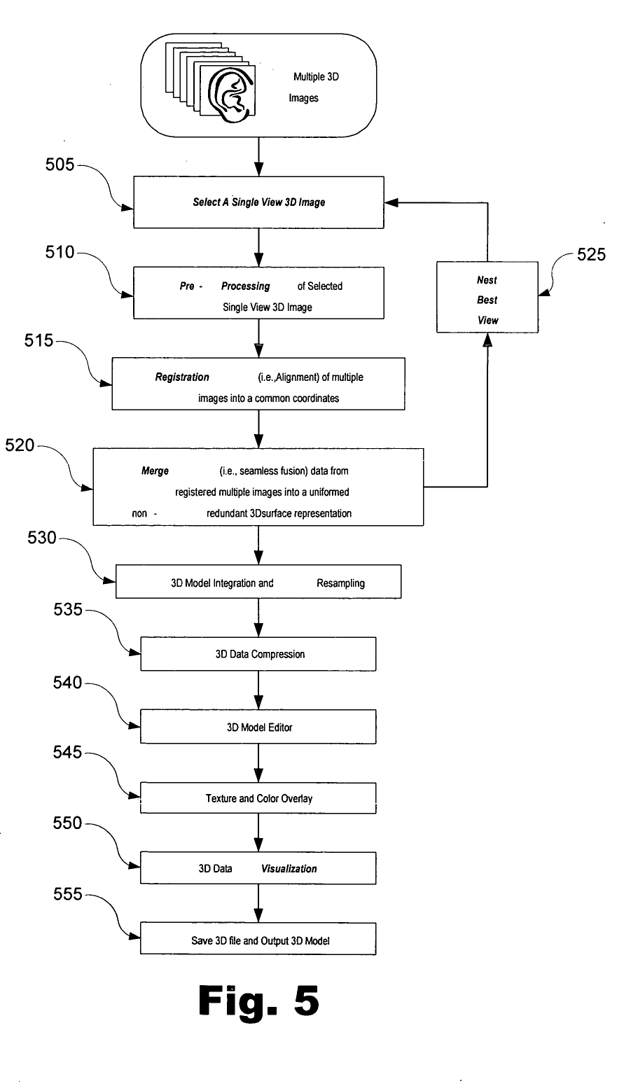

A 3D image registration technique is described herein that reduces or eliminates the need of a prior knowledge of pre-calibrated cameras and provides a semi-automatic software environment to integrate 3D images captured by handheld 3D cameras. The idea of our free-form alignment is outlined step 500-555 in FIG. 5. Automatic selection of corresponding points from both images for “course” alignment will be discussed briefly. Although tracking feature points between multiple frames is by and large a solvable problem, automatic selecting feature points in multiple images of arbitrary scene may be difficult.

An effective feature point selection method may be based on KLT techniques. For example, a feature may be described as a textured patch with high intensity variation. Features may include, without limitation, corners and spots on an image. During detection, a[2×2] gradient matrix for each pixel is used to calculate its two eigenvalues. If both of them exceed a predefined threshold, it is accepted as a candidate feature.

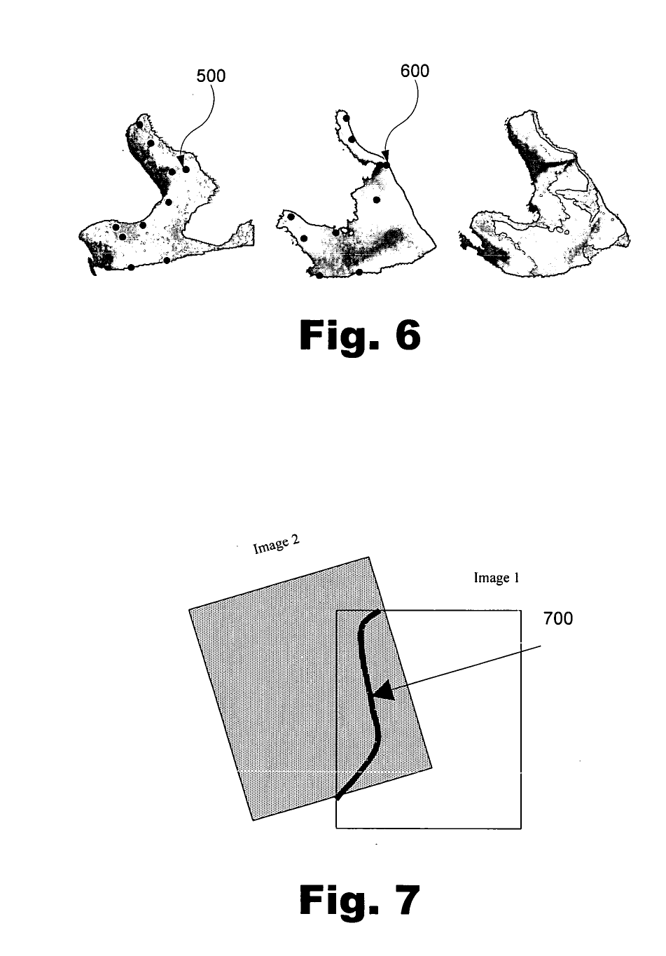

After evident features are selected from the first frame, a search is performed for their counterpart on the second frame in a window around their corresponding positions. By iteration, displacement between the same features on those two frames is obtained. FIG. 6 shows an example of feature extraction for 3D ear image registration. The feature points (600), shown as black dots, are fairly consistent between frames. The affine transformation between different images can be calculated using least mean square method based on the locations of these points.

Once we have a set of local landmark points on both surfaces of 3D images to be integrated, we can derive a homogenous spatial transformation (R′,T′) to align them into a common coordinate system. R′ is rotation matrix and T′ is the translation vector. The manual alignment is able to bring two overlapping images together in a course alignment. Computer algorithm will be used to further optimize the alignment.

The alignment optimization process is illustrated in FIG. 23, where surface A and surface B are course aligned via manual process. We denote corresponding point pairs on surface A and surface B as Aᵢ and Bᵢ, i=1,2, . . . , n. We can define an index of least-squared distance as:

$$I = {\sum }_{i = 1}^{n} {\vert {A}_{i} - R ( {B}_{i} - {B}_{c} ) - T \vert}^{2} ,$$

where T is the 3D distance between the centroid of the point Aᵢ and the centroid of the point Bᵢ. B_{c} is the center of B surface. R is found by constructing a cross-covariance matrix between centroid-adjusted pairs of points. By minimizing index I, we can find a rigid transformation (R, T) that minimizes the least-squared distance between point pairs Aᵢ and Bᵢ. The “Fine” alignment is an iterative process and it will stop when the pre-defined error tolerance is met.
Stitch Two Images Together and Re-Sampling

There are several methods to generate the final surface description of merged object. One such method is to simply stitch the boundary area between two meshes, and a second method is to re-sample a much larger area of surface to obtain a more or less evenly distributed triangle description. The first method is conceptually simple. However, connecting triangles from two different surfaces creates an exponential number of ways to stitch two surfaces, thus it is computationally expensive to optimize the selection. This problem is exacerbated by noise in the data and errors in alignment procedures.

FIG. 7 illustrates a method for determining the boundary between two 3D images for stitching. The idea is based on “equal-distance” between raw data sets. Given two overlapping 3D images with arbitrary shapes on image edges, the ideal boundary line (700) can be determined on which each point possesses an equal distance from two overlapping edges.

We have developed a method that performs the re-sampling operation on the merged surface with more or less even density of triangle vertices. Briefly speaking, the re-sampling process starts with selecting the desired grid size (i.e., average distance between neighboring sampling points on the 3D surface). Then, the linear or quadratic interpolation algorithm may be used to calculate the 3D coordinates on the sampled points, based on the 3D surface points on the original 3D images. In areas where two 3D images overlap, the smooth function will be applied to calculate the coordinate values on the re-sampling points.

Intelligent Compression of 3D Image

A 3D model is a collection of geometric primitives that describes the surface and volume of a 3D object. The size of a 3D model of a realistic object such as the ear impression is usually huge, ranging from several to several hundred MB files. Processing such a huge 3D model may be very slow, even on the state-of-the-art high-performance graphics hardware. Transfer of such a huge data set often causes serious problem for computer network and data storage devices. Therefore, an intelligent 3D model compression method has to be developed. Since 3D model usually can be expressed as polygons, the 3D image compression is equivalent to the polygon reduction process.

We define the 3D image compression as a process of reducing the number of geometric primitives in a 3D model while minimizing the difference between the reduced and the original models. We have developed a 3D image compression method that minimizes the 3D distance between the original model and the reduced one. We also emphasize the preservation of important surface features, such as surface edges and local topology, to maintain the realism of the reduced model.

The present3D image compression method can compute the optimal reduction of triangle number as specified by users. The reduction level specified by users can be given in two different manners: by indicating an error tolerance level in model units, or by specifying a number of triangles for the reduced model. The compression process may then be a substantially fully automatic process and users may not have to supply the algorithm with esoteric geometric parameters.

The 3D compression program includes a multi-resolution triangulation algorithm that can optimally reduce the number of triangle vertices. First, the program would input the 3D data file and transfer 3D polygon into 3D triangles. Then, a sequential optimization process iteratively removes triangulation vertices based on the error tolerance. The 3D distance between the original and reduced 3D model is then calculated to ensure the fidelity of the reduced model.

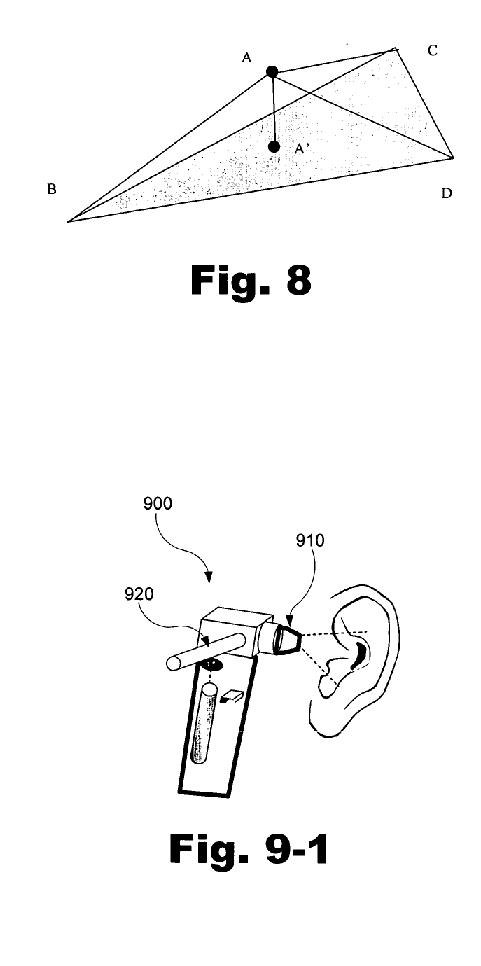

As shown in FIG. 8, the “3D distance” is defined here as the distance between the removed vertex (denoted as A) on the original model and the extrapolated 3D point (denoted as A′) based on the reduced 3D model. A′ is on the plane formed by vertices B, C, D in a case when a linear extrapolation method is used. Once this maximum 3D distance among all the removed points exceeds a pre-specified tolerance level, the program will save the reduced model in a file. In determining the performance of an exemplary algorithm, the de facto standard test object was used—the 3D model of a Bunny obtained from Stanford University to evaluate the performance of our 3D compression algorithm. The original model has 16301 triangles. Four successive compression models have 12574, 5499, 1729, and 401 triangles respectively. The running time for obtaining all these models is about 2 minutes.

Dual Head Ear Camera

FIGS. 9-1 and 9-2 illustrate a dual view of view (DFOV) camera (900) that makes use of two separate camera heads (910, 920). S1˜3 represent light sources. DF1˜3 for light collection optics (diffusers), CL1˜3 for intermediate optics, P1˜3 for pattern filters, M1˜3 for reflective mirrors, DC2˜3 for prism beamsplitters, and CL for objective lens and CCD for image sensors. The first head, the wide view of view (WFOV head) (910) will be designed for imaging external ear structure. It has a wide field of view (WFOV). The second camera head (920) will be designed as a narrow probe for imaging ear canal structure. The second camera has a narrow field of view head (NFOV head) (920) in order to get access into ear canal. One exemplary second camera head (920) may be similar to the inner canal imaging device (300; FIG. 3).

FIG. 9-1 illustrates the imaging device (900) imaging the external structure using the WFOV head (910). FIG. 9-2 shows the concept of imaging ear canal using a narrow probe with NFOV. Both camera heads, placed in 90-degree angle, share the same multi-rainbow projection (MRP) engine and use the same handheld unit. The ergonomic design of the handheld unit shape may allow an operator to acquire 3D images in both configurations. The software will be design to seamlessly integrate all 3D images together.

The DFOV camera (900) makes use of two separate multi-rainbow projection (MRP) paths. Instead of building two separate sets of MRP engine, the imaging device (900) according to one exemplary embodiment makes use of a single MRP optical configuration that has a prism beamsplitter, as shown in FIG. 10 before object lens. Due to the use of this prism BS, 50% of illumination energy is reflected toward a direction 90-degree from the intended projection angle. The direction of the side-view MRP illumination is 90-degree from the main projection direction.

This projector generates the multi-rainbow projection in two directions 90-degree apart. The separation of two MRP projection beams from the primary MRP engine is conceptually straightforward. The narrow FOV optical projection system needs to have an entirely new design. Ear canal is a small cavity. The optical probe that is designed to measure the shape of ear canals should have small diameter (<2 mm), with focal length <2 mm, wide field of view (˜120-degree FOV), and a resolution of about 50 microns. We performed an integrated design of packaging both the MRP channel and the CCD image acquisition channel into a thin probe (a few mm in diameter).

We selected image sensor for the NFOV imaging channel. Dual to its compact size, we may choose ¼″ CCD chip to collect video image. There are image sensor IC Chips commercially available to perform integrated image acquisition, processing and interface with CCD (such as OV7620 from OmniVision Tech and ICX038DNA/ICX058CK from SONY). Also, there are high-resolution and low-cost CMOS chips available on the market.

Software

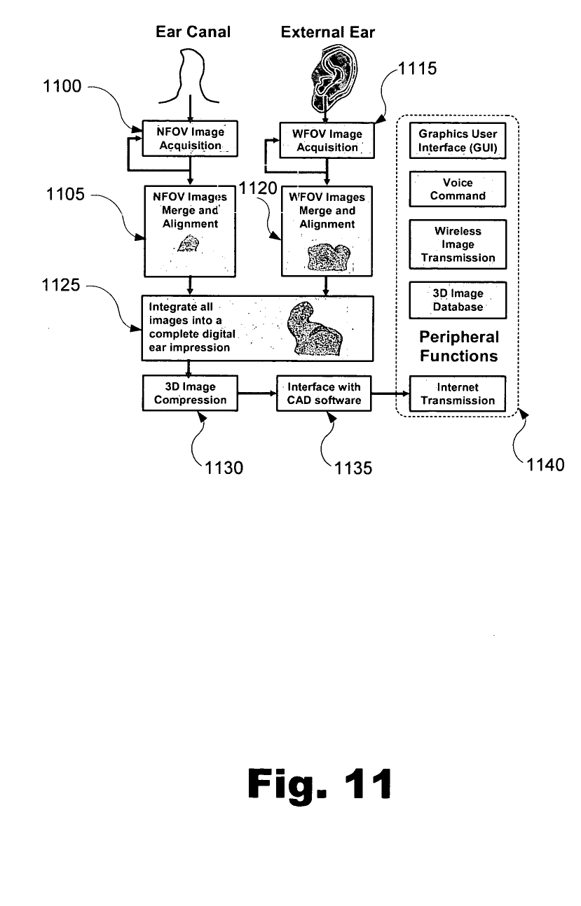

The major functional blocks of exemplary application software architecture are illustrated in steps 1100-11 FIG. 11. In particular, the narrow field of view image is acquired (1100) and the NFOV images are merged and aligned (1105) as previously described. Similarly, the WFOV images are acquired (1115) and then aligned and merged (1120). The NFOV model and WFOV model are then merged (1125), the image is compressed (1130), and then sent to interface with CAD software (1135). The CAD software then sends the model to peripheral functions (1140).The application software may make use of COM and/or Rational Rose, as well as some other tools, we are developing a common architecture for all of our image processing products. This architecture may provide speed in development through a systems approach and common interface standard (COM), promote modular software design, maximize reuse of software “components”, better adaptability to customer requirements, spiral development through limiting technology insertion to specific testable software modules, more “robust” software through a highly-testable and modular architecture, better support and maintainability of the software and algorithms.

Given two or more 3D surfaces from a same object captured at different direction with partially overlapping, 3D registration technique is used to bring those surfaces into the same coordinates system for further application. One elegant method called Iterative Closest Point (ICP) algorithm is very effective in registering two 3D surfaces. See Zhengyou Zhang, Iterative Point Matching for Registration of Free-Form Curves and Surfaces, International Journal of Computer Vision, 13, z, 1994, pp 119-15. The idea of ICP algorithm is, given two sets of 3D points representing two surfaces called P and X, find the rigid transformation as defined by rotation R and translation T, which minimizes the sum of Euclidean square distances between the corresponding points of P and X. The sum of all square distances gives rise to the following surface matching error

$$e ( R , T ) = {\sum }_{k}^{N} {‖ ( {Rp}_{k} + T ) - {x}_{k} ‖}^{2} , {p}_{k} ∈ P and {x}_{k} ∈ X .$$

By iteration, optimum R and T are found to minimize the error e(R, T). In each step of the iteration process, the closest point xₖ on X of pₖ on P is obtained by effective search structure such as k-D tree partitioning method.

An initial guess brings the two surfaces to together roughly. Otherwise it will converge to some local minimum. This can be done by manually selecting some corresponding feature points on those two surfaces. But in many applications such as the 3D ear camera, automatic registration is desired before it eliminates the user intervention and saves significant time in the image processing. Several references, including. C. Chen, Y. Hung, and J Cheng, RANSAC-Based DARCES: A New Approach to Fast Automatic Registration of Partially Overlapping Range Images, Trans. PAMI, Vol. 21, No. 11, 1999, L. Lucchese, G. Doretto, G. M Cortelazzo A Frequency Domain Techniue for 3-D View Registration IEEE Transactions on PAMI, 24(11), 1468-1484, 2002] and A. Johnson and M. Hebert, Using spin images for efficient object recognition in cluttered 3D scenes, IEEE Transactions on PAMI, Vol. 21, No. 5, May, 1999, pp. 433-449 discuss some approaches to solve the problem of initial registration. The method in Chen et al. is time consuming and not realistic for real-time application. The method in Lucchese et al. will introduce extra noise into the process and still need user intervention. It is also time consuming. The method in Johnson et al. may only work in limited circumstances. Therefore more reliable and fast method must be developed for the practical application in 3D vision.

The solution described herein is, through feature tracking through a video sequence, the correspondence between two 2D images can be constructed. Then camera motion can be obtained by Structure From Motion (SFM) method. A good feature is a textured patch with a high, intensity variation in both x and y directions, such as corner. Denote the intensity function by I(x, y) and consider the local intensity variation matrix as

$$z = [ \begin{matrix}\frac{{\partial }^{2} I}{\partial {x}^{2}} & \frac{{\partial }^{2} I}{\partial x \partial y} \\ \frac{{\partial }^{2} I}{\partial x \partial y} & \frac{{\partial }^{2} I}{\partial {y}^{2}}\end{matrix} ]$$

A patch defined by a 25×25 window is accepted as a candidate feature if in the center of the window both eigenvalues of Z, λ₁ and λ₁, exceed a predefined threshold λ: min(λ₁, λ₂)>λ.

KLT feature tracker is used for tracking good feature points through a video sequence. This tracker is based on the early work of Lucas and Kanade See. Bruce D. Lucas and Takeo Kanade. An Iterative Image Registration Technique with an Application to Stereo Vision. International Joint Conference on Artificial Intelligence, pages 674-679, 1981. The concept was developed more fully by Tomasi and Kanade. See. Jianbo Shi and Carlo Tomasi. Good feature to track, IEEE Conference on Computer Vision and Pattern Recognition, pages 593-600, 199]. Briefly, good features are located by examining the minimum eigenvalue of each 2 by 2 gradient matrix, and features are tracked using a Newton-Raphson method of minimizing the difference between the two windows.

After having the corresponding feature points on multiple images, 3D scene structure or camera motion from those images can be recovered from the feature correspondence information. See. Hartley, R. I. [Richard I.], In Defense of the Eight-Point Algorithm, PAMI(19), No. 6, June 1997, pp. 580-593] and. Z. Zhang, R. Deriche, O. Faugeras, Q.-T Luong, “A Robust Technique for Matching Two Uncalibrated Images Through the Recovery of the Unknown Epipolar Geometry”, Artificial Intelligence Journal, Vol. 78, pages 87-119, October 1995. But the results are either unstable or need the estimation of ground truth. In Zhang et al., only a unit vector of translation T can be obtained.

A novel and simple approach is, with the help from 3D surfaces corresponding to 2D images, 3D positions of those well-tracked feature points can be used directly for the initial guess of 3D registration. With the ICP and automatic feature tracking techniques, the whole process of 3D image registration may becomes substantially automatic. According to one exemplary method, this process includes, Step 1. Capture one 3D surface through 3D camera. Step 2. When moving to next position, capture the video sequence and do feature tracking. Step 3. Capture another 3D surface at the new position. Step 4. From tracked feature points on 2D video, get the initial guess for 3D registration. Step 5. Use ICP method to refine the 3D registration.

After each 3D image has been aligned (i.e., registered) into a same coordinate system, the next step is to create a single 3D surface model from those range images. There are mainly two approaches to generate this single 3D iso-surface model, mesh integration and volumetric fusion. See Turk, G., M. Levoy, Zippered polygon meshes from range images, Proc. of SIGGRAPH, pp. 311-318, ACM, 1994 and Curless, B., M. Levoy, A volumetric method for building complex models from range images, Proc. of SIGGRAPH, pp. 303-312, ACM, 1996, which are hereby incorporated by reference in their entireties.

The mesh integration approach in Turk et al deals with simple cases such as at most two range images are involved in the overlapping area. Otherwise it will be too complicated to build the relationship of those range images. The overlapping area will merge into an iso-surface. On the contrast, the volumetric fusion approach in Curless et al. is kind of a general solution which is suitable for various circumstances. For instance, for full coverage, dozens of range images are to be captured for an ear impression. Quite a few ranges will overlap to each other. The volumetric fusion approach is based on the idea of marching cube, which creates a triangular mesh that will approximate the iso-surface. Algorithm for marching cube is outlined below: Step 1: Locate the surface in a cube of eight vertexes. Step 2: Assign outside 0 to vertex outside the surface and 1 to vertex inside the surface. Step 3: Generate triangles based on surface-cube intersection pattern (FIG. 38). Step 4: March to the next cube.

Voice Control Command

Voice control commands may be utilized to One possible way to solve this problem is to incorporate the latest advances in voice recognition technology. With “limited vocabulary”, the voice commands could be very effective and reliable. The system can host infinite number of commands, without changing hardware.

Wireless Image Transmission

A desirable feature of any handheld unit may be the elimination of tether wire. We have adopted the LED light sources in our camera design so that there is no need for heavy fiber optical cable for deliver light into the handheld unit—very limited amount of power supplier (could be from battery) is needed to make the light source work. Other wires may be used for transmitting video image signals and control command signals. These signals can be transmitted effectively via wireless channels. Another function provided includes a capability of transmitting 3D data, after compression to proper size, to remotely located manufacturer sites.

Shape From Motion 3D Imaging

FIG. 12 illustrates an inner canal imaging device (1200) that make use of forward looking optics (310-1) to provide a panoramic 360° FOV. The forward looking optics (310-1) directs images from the 360° FOV as previously discussed to an image sensor. Data corresponding to this data is them processed by a shape from motion (SFM) algorithm based on a single sensor, multi-frame dynamic stereo methodology. An exemplary SFM algorithm is shown in FIG. 13. Image sequences are acquired as the intra-ear probe moves along the ear canal. Image pairs from two different camera locations are used to construct 3D geometry of the tracked image/feature points. In addition, multiple image pairs are also used to increase the accuracy of the reconstructed 3D model of the scene.

Multi-frame Dynamic Stereo

As shown in FIG. 13, after successful feature extraction/tracking, a nonlinear least square or Levenberg-Marquardt (LM) estimation method is used to continuously estimate camera poses and 3D locations of the tracked features. The obtained camera pose information enables the localization of epipolar constraints, which is useful for dense map 3D reconstruction from an image pair. Instead of using any image pairs with any baseline distances to construct 3D information of a scene, we select pairs with large baseline distances. This greatly increases the accuracy and robustness of the reconstructed results. 3D reconstructed information from multiple image pairs is fused through the Sum of Squared Difference (SSD) method described below.

The OmniScope: (1) uses a single camera, thus making it more feasible to fabricate a miniature device and reducing the cost of the system; (2) uses 360° FOV, making ear canal reconstruction possible with simple camera motion; (3) It offers stereo setup with flexible baseline distances; and (4) It provides higher 3D resolution from multiple image pairs with large baseline distances.

Image Calibration for Omni-Lens Imaging System: The 360° imaging sensor is calibrated to recover its intrinsic parameters, which include image center, focal length, aspect ratio, Onmi-Lens to sensor transformation, etc. Genex has designed and calibrated the OmniEye product where Omni-mirror was used for imaging. Based on our past experience, we will develop a reliable calibration method for the OmniScope.

Automatic and Reliable Feature Extraction and Tracking: Our feature extraction and tracking scheme through video sequencing is based on the KLT (Kanade Lucas Tomasi) tracker, which is based on the early work of Lucas and Kanade [Iterative Image Registration Technique with an Application to Stereo Vision. Int. Joint Conf. on Artificial Intelligence, 1981.] and later by Tomasi [Good feature to track, IEEE Conf. CVPR, 1994]. Briefly, good features are defined as textured patches with high intensity variation in both x and y directions, such as a corner.

The KLT tracker is however a passive feature tracker. It can only blindly search for the correspondence within a pre-defined threshold related region. We propose to develop an improved tracking method that uses an active feature extraction and tracking scheme by integrating camera relative coarse position into the algorithm. By using the camera's relative position, we can localize feature searching, thus greatly reducing false alarms, miss-detection, and improving the computational speed.

Automatic Camera Pose Estimation: The feature points are used to recover the camera's motion and the 3D locations of the tracked feature points by minimizing the error between the tracked point locations and the image locations predicted by the shape and motion estimates. Because we recover six degrees-of-freedom (DOF) translation and rotation parameters for each image and a 3D position for each tracked feature point, the total number of estimated parameters is 6f+3p, where f is the number of images and p is the number of points.

Suppose we have acquired m images and there are n 3D points tracked. Let Pᵢ (Xᵢ, Yᵢ, Zᵢ) be 3D point i_{ε}{1, . . . , n}, and pᵢⱼ(xᵢⱼ, yᵢⱼ) (where j_{ε}={1, . . . , n} be its image. Let camera positions be represented by the rotation Rⱼ and translation Tⱼ. Let n: R₃→R₂ be the projection which gives the 2D image location for a 3D point, determined by imaging sensor calibration (see T2.1). To recover the camera motion and structure parameter, we use the Levenberg-Marquardt (LM) algorithm[W. H. Press et al. Numerical Recipes in C, Cambridge Univ Press, 1992], which iteratively adjusts the unknown shape and motion parameters {pᵢⱼ} and {Rⱼ, Tⱼ} to minimize the weighted square distance between the predicted and observed feature coordinates:
σ=Σ|pᵢⱼ−Π(RⱼPᵢ+Tⱼ∥²
where the sum is over all i, j such that point i was observed in image j. Obtain High Resolution 3D Image Using Image Pairs with Large Baseline Distance:

While a 3D scene can be theoretically constructed from any image pairs, due to the errors from the camera pose estimation and feature tracking, image pairs with small baseline distances will be much more sensitive to noise, resulting in unreliable 3D reconstruction. In fact, given the same errors in camera pose estimation, bigger baselines lead to smaller 3D reconstruction error.

We propose an innovative concept using only image pairs with large baseline distances for reconstructing 3D images, taking full advantage of stereo formation and resulting in high resolution 3D data to satisfy the stringent 100 micron spatial resolution requirement. In the meantime, since we track features at video rate, our approach avoids miss-tracking features and reduces errors of camera pose estimation. In our approach, large baseline distance is defined based on time sequence and feature disparity. If the time sequence gap and feature disparities of an image pair are greater than certain thresholds, this image pair will be perceived as having large baseline distance.

Improve reliability and Resolution by Using Multiple Image Pairs: Instead of using single image pairs for a 3D point reconstruction, we propose a novel solution using image pairs of different baseline distances (all satisfy the “large baseline distance” requirement defined in T.2.4.). As shown in FIG. 13, this multi-frame approach allows us to reduce the noise and further improve the accuracy of the 3D image. Our multi-frame 3D reconstruction is based on a simple fact from stereo equation:

$$\frac{Δ d}{B} = \frac{f}{Z} = f * \frac{1}{Z} = λ .$$

This equation indicates that for a particular data point in the image, the disparity Δd divided by the baseline length B is constant since there is only one distance Z for that point (f is focal length). If any evidence or measure of matching for the same point is represented with respect to λ, it should consistently show a good indication only at the single correct value of λ independent of B. Therefore, if we fuse or add such measures from image pair with multiple baselines (or multi-frames) into a single measure, we can expect that it will indicate a unique match position.

The SSD (Sum of Squared Difference) over a small window is one of the simplest and most effective measures of image matching. The curves SSD1 to SSDn in FIG. 13 show typical curves of SSD values with respect to λ for individual stereo image pairs. Note that these SSD functions have the same minimum position that corresponds to the true depth. We add up the SSD functions from all stereo pairs to produce the sum of SSDs, which we call SSSD-in-inverse-distance. The SSSD-in-inverse-distance has a more clear and unambiguous minimum.

Automatic Feature Tracking:

Frame-to-frame automatic feature tracking poses significant challenges when the camera has random motion. The KLT tracker is designed with parameters that predefine a feature searching window of a certain distance away from a reference image. These parameters are actually a function of camera motion. In reality, different audiologists may operate the 3D camera differently, which means that using fixed parameters for the algorithm may not be sufficient for some applications. The alternative approach is to integrate the camera's relative position into the algorithm, making the tracking dynamic.

Finding the Global Minimum Solution

Unlike traditional stereo where a camera's pose is pre-calibrated, SFM algorithms need to correctly estimate camera poses over time. With the proposed Levenberg-Marquadt estimation method, there is a risk that it leads to a local minimum solution. A unique scene pattern may be printed on the interior of a balloon to avoid this situation. Feature patterns can be designed to allow reliable feature tracking and avoid degenerated cases.

A disposable miniature air balloon is shown in FIG. 16 at the distal end of the probe to assist the intra-ear imaging operation. The balloon is inflated in the canal and pressed against the ear surface with low air pressure. The balloon uses very flexible materials that can stretch its volume over 600%. The imaging device (1200) is able to move inside the balloon and acquire 3D images from inside the balloon. The balloon can be inflated through a manual air pump. The pump is simply a plastic squeezable ball. The camera probe goes into the balloon through a ring, which provides an airtight seal. The flexible vent pipe helps to take air out when the balloon deflated. The vent pipe may be taken out once the balloon is fully attached to the inner wall of the ear. Image sequences are acquired as the probe moves inside the balloon through the air valve. The major functions of the disposable balloon include:

Instead of imaging skin surface with inconsistent feature patterns, the OmniScope imaging probe acquires 3D images of the balloon surface that complies with the canal shape. The surface of the air balloon will be printed on random or designed rich surface features to ensure the consistency of the SFM registration algorithm performance.

There is a non-compliant patch embedded inside the balloon that has known dimensions. The SFM algorithms can use it to determine the absolute scaling of the 3D model. The use of a disposable balloon keeps the imaging probe free from earwax, fingerprints, or other types of contamination, thus ensuring imaging quality and patient health. The disposable balloon provides an easy mechanism to collect a “per use” charge for the 3D Intra-ear OmniScope that generates recurring revenues.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

1. A 3D Camera system for facilitating the manufacturing of custom fit hearing aids comprising:
a video camera for capturing 3D data images of a patient's ear canal,
a processor for aligning and morphing said video images to generate merged 3D images of the patient's inter ear canal, and
an output terminal for connecting said merged video data of the patient's inter ear to derive a CAD/CAM device to generate the patient's custom fit hearing aid.

2. A process for automating the manufacture of custom fit hearing aids comprising the steps of:
developing a plurality of video images of the interior of a patient's ear canal,
aligning all of the video images of the patient's inter ear canal, and integrating all of the 3D video images into digital data to drive a CAD/CAM machine to the custom fit hearing aid for the patient.

3. The process of claim 2 wherein the step of developing comprises the step of utilizing a 3D Rainbow Camera to generate a plurality of 3D data images.

4. The process of claim 3 wherein the step of utilizing comprises the step of selecting a near field of view video cameras to acquire said 3D images.

5. The process of claim wherein the step of utilizing a 360 degree stereoscopic video camera.

6. The process of claim 5 wherein the step of acquiring comprises the step of simultaneously combining a forward looking and a peripheral panoramic imaging camera.

7. A process for developing a custom fit ear plug to function as a speaker unit for a cell phone comprising the steps of:
acquiring a plurality of video images of an ear canal of a cell phone customer to be fitted with a custom fit ear plug,
generating a 3D data set from said plurality of video images to accurately describe the ear canal of said customer,
utilizing said 3D data set to drive a CAD/CAM device to fashion said custom fitted ear plug for said customer, and
combining said cell phone speaker unit within said custom fitted ear plug for said customers.

8. The process of claim 1, wherein the step of combining additionally includes the step of positioning with each speaker unit an electronics unit for providing associated electronic control for both speaker unit and a microphone pick up unit.

9. The process of claim 2, wherein the step of combining additionally comprises the step of fashioning said custom fitted ear plug in multiple pieces to facilitate the assembly of said speaker unit and said microphone unit within a cavity of said assembled custom fitted ear plug.

10. The process of claim 1, wherein said step of acquiring said plurality of video images is combined with the step of selling to said customer a cell phone at a retail store.

11. Apparatus for fabricating a custom fitted ear plug to function as an audio unit of a cell phone comprising:
means for acquiring a plurality of video images of a customer's ear canal,
means for generating a 3D data set from said plurality of video images to accurately describe the dimensions of the customers ear canal, and
means for utilizing said 3D data set to fabricate a custom fit ear plug for housing said audio unit of said cell phone.

12. An imaging device, comprising:
a light source configured to project spatially varying light onto a surrounding scene;
an image sensor; and
imaging optics configured to direct said light from said surrounding scene onto said image sensor wherein a portion of said optics is configured to be placed within an inter ear canal.

13. The device of claim 12, wherein said imaging optics include at least one lens configured to establish one-to-one correspondence between a location in said surrounding scene and a location on said image sensor.

14. The device of claim 12, wherein said imaging optics includes a lens and a convex mirror separated by a known distance.

15. The device of claim 14, wherein said lens is associated with a forward looking portion of said sensor to establish a one-to-one correspondence between a location in said surrounding scene and said mirror is associated with said sensor to establish a one-to-one correspondence between said location in said surrounding scene and a rearward looking portion of said sensor.

16. The device of claim 14, wherein said imaging optics further comprises relay optics.

17. The device of claim 16, wherein said imaging optics comprises a rod lens.

18. The device of claim 17, wherein said imaging optics comprises an iris configured to collimate light directed to said sensor.

19. The device of claim 12, wherein said light source comprises a multiple rainbow projection device.

20. The device of claim 19, wherein said light source includes a plurality of light emitting diodes.

21. The device of claim 12, and further comprising a plurality of fiber optic fibers and a light ring optically coupled to said light source for directing spatially varying light to said surrounding scene.

22. An imaging device, comprising:
a first imaging head configured to direct images from an narrow field of view to a first image sensor; and
a second imaging head configured to direct images from an outer wide field of view to a second sensor.

23. The image device of claim 22, and further comprising a spatially varying light source configured to direct light to both said narrow field of view and to said wide field of view.

24. The imaging device of claim 23, wherein said spatially varying light source comprises a multiple rainbow projector.

25. The imaging device of claim 22, first imaging head includes a lens and a convex mirror separated by a known distance.

26. The image device of claim 25, wherein said first imaging head further includes relay optics.

27. The device of claim 26, wherein said relay optics include an iris lens and a rod lens.

28. An imaging system, comprising:
a light source configured to project spatially varying light onto a surrounding scene;
an image sensor;
a lens configured to direct said light from said surrounding scene onto said image sensor wherein a portion of said optics is configured to be placed within an inner ear canal; and
a processor configured to generate three-dimensional models of an inner ear canal based on multiple two-dimensional images acquired by moving said lens within said inner ear canal.

29. The system of claim 28, and further comprising a conformable member configured to be placed within said inner ear canal to conform to the surface of said inner ear canal and to have said lens placed therein.

30. The system of claim 29, wherein said conformable member includes features formed therein.

31. The system of claim 30, wherein said features includes a substantially non-deformable member having known dimensions.
